(19) United States
(12) Patent Application Publication
(10) Pub. No.: US 2025/0036880 A1
(43) Pub. Date: Jan. 30, 2025

(54) SYSTEM AND METHOD FOR NATURAL LANGUAGE PROCESSING FOR QUALITY ASSURANCE FOR CONSTRUCTED-RESPONSE TESTS

(71) Applicant: ACUITY INSIGHTS INC., Toronto (CA)

(72) Inventors: Cole WALSH, Toronto (CA); Okan BULUT, Toronto (CA); Alexander MACINTOSH, Toronto (CA)

(21) Appl. No.: 18/891,609

(22) Filed: Sep. 20, 2024

Related U.S. Application Data
(63) Continuation-in-part of application No. 18/847,936, filed on Jan. 1, 0001.
(60) Provisional application No. 63/392,310, filed on Jul. 26, 2022.

(51) Int. Cl. G06F 40/30

(52) U.S. Cl. CPC G06F 40/30

(57) ABSTRACT

Embodiments described herein provide systems and processes for natural language processing for quality assurance and response assessment of a situational judgement test. For example, system can use natural language processing engine for sentiment analysis and unsupervised text classification to automatically score or rate response data. The system can provide quality assurance for rating data by generating predicted scorings or ratings that can be compared to human rating data.

### CROSS REFERENCE TO RELATED APPLICATION

This application is a continuation-in-part of U.S. patent application Ser. No. 18/847,936, filed Sep. 17, 2024, which is a national phase entry of International Application No. PCT/CA2023/050988, filed Jul. 25, 2023, and which claims priority to and the benefit of U.S. Provisional Application No. 63/392,310, filed Jul. 26, 2022, entitled SYSTEM AND METHOD FOR NATURAL LANGUAGE PROCESSING FOR QUALITY ASSURANCE FOR CONSTRUCTED-RESPONSE TESTS, the entire contents of which is hereby incorporated by reference.

### FIELD

The improvements generally relate to the field of computer systems, natural language processing, networking, and distributed hardware. The improvements, in particular, relate to distributed computer implemented assessment systems with natural language processing for quality assurance of rating data and assessing response data for constructed-response tests, such as, for example situational judgement tests (SJTs) or tests with open-responses.

### INTRODUCTION

Tests, such as, for example, SJTs measure various non-cognitive skills (including but not limited to professionalism, situational awareness, and social and emotional intelligence) based on examinees' actions for hypothetical real-life scenarios. To assess the validity of scores obtained from constructed-response tests, a quality assurance (QA) framework can be useful. Embodiments described herein provide for distributed computer assessment systems, and in particular, embodiments described herein provide for assessment systems with natural language processing for quality assurance of rating data and assessing response data.

### SUMMARY

In an aspect, embodiments described herein provide a system for natural language processing for quality assurance and automatic response assessment for constructed-response tests. The system has: a memory storing one or more generative models; a processor coupled to the memory programmed with executable instructions, the instructions including an interface for obtaining response data for a constructed-response test from a plurality of examinee electronic devices, wherein the processor executes the instructions to provide a natural language processing engine to generate predicted rating data for the response data for the constructed-response test using one or more generative models and one or more large language models, wherein the predicted rating data comprises ratings or scores of the response data for the constructed-response test, wherein the processor compares the predicted rating data to the response data and generates quality assurance data based on results of the comparison using one or more models, wherein processor uses the one or more generative models to generate feedback data about the response data, wherein the quality assurance data comprises the feedback data, wherein the processor uses the predicted rating data and the feedback data for one or more of identification of improvement areas, generation of individualized learning plans, curriculum reform, and monitoring; wherein the processor receives the response data from the plurality of examinee electronic devices, each of the devices having a transceiver for transmitting collected response data to the interface.

In some embodiments, the processor de-personalizes the response data and aggregates de-personalized response data for automating program or curriculum review.

In an aspect, embodiments described herein provide a system for natural language processing for quality assurance and response assessment for constructed-response tests. The system comprising: a memory; a processor coupled to the memory programmed with executable instructions, the instructions including an interface for obtaining response data for a constructed-response test, wherein the processor executes the instructions to provide a natural language processing engine for sentiment analysis and unsupervised text classification to generate predicted rating data for the response data for the constructed-response test, wherein the predicted rating data comprises ratings or scores of the response data for the constructed-response test, wherein processor uses the one or more generative models to generate feedback data about the response data; and a plurality of examinee electronic devices, each examinee electronic device configured for collecting the response data for the constructed-response test, the device having a transceiver for transmitting the collected response data to the interface.

In an aspect, embodiments described herein provide a computer process for natural language processing for quality assurance and response assessment for constructed-response tests, the process comprising: by a processor coupled to memory programmed with executable instructions, the instructions including an interface for obtaining response data for a constructed-response test, wherein the processor executes the instructions to provide a natural language processing engine, generating, using the response data, combined response data for multiple questions for a scenario of the constructed-response test; extracting features from the combined response data; generating training data set and testing data set from the features; developing, training and validating one or more models using the training data; selecting a model from the one or more models; generating predicted ratings using the selected model and sentiment analysis and unsupervised text classification, wherein the predicted rating data comprises ratings or scores of the response data for the constructed-response test; generating feedback data for the response data using the predicted ratings; and transmitting the feedback data to an electronic device for display or storing the feedback data in the memory.

In an aspect, embodiments described herein provide systems and processes for natural language processing for quality assurance of rating data and assessing response data of constructed-response tests or open response tests. The constructed-response tests measure various non-cognitive skills including but not limited to professionalism, situational awareness, and social intelligence. In some embodiments, the systems and processes for natural language processing for quality assurance of rating data and assessing response data of constructed-response tests or open response tests to measure various cognitive skills. As another example, SJTs can also be used to measure various non-cognitive skills, such as, emotional intelligence.

In an aspect, embodiments described herein provide a computer system for natural language processing for quality assurance of rating data and assessing response data for constructed-response tests. The system has a memory, and a processor coupled to the memory programmed with executable instructions, the instructions including an interface for obtaining rating data and response data for a constructed-response test, wherein the processor executes the instructions to provide a natural language processing engine to generate predicted rating data for the response data for the constructed-response test, wherein the processor compares the predicted rating data to the rating data and generates quality assurance data based on results of the comparison, and wherein the processor using one or more generative models to generate feedback data about the response data, wherein the quality assurance data comprises the feedback data. The system has an examinee electronic device for collecting the response data for the constructed-response test, the device having a transceiver for transmitting the collected response data to the interface. The system has a rater electronic device for collecting the rating data for the response data for the constructed-response test, the electronic device having a transceiver for transmitting the collected rating data and feedback data to the interface.

In some embodiments, the processor generates, using the response data, combined response data for multiple questions for a scenario of the constructed-response test.

In some embodiments, the processor extracts features from the combined response data, and generates training data set and testing data set from the features.

In some embodiments, the processor develops, trains and validates one or more models using the training data.

In some embodiments, the processor selects a model from the one or more models, and generates the predicted ratings using the testing data set and the selected model.

In some embodiments, the processor selects a model from the one or more models, and generates feedback data using the response data and the selected models.

In some embodiments, the processor rates formative assessments automatically, without (a significant degree of) human rater use for generating output.

In some embodiments, the processor(s) assess the assessment responses automatically and maps out the degree to which an individual relies upon one heuristic as compared to others.

In some embodiments, the processor transmits the quality assurance output data to the rater electronic device for display or stores the quality assurance output data in the memory.

In some embodiments, the processor transmits the response data to the rater electronic device for display or stores the feedback data in the memory.

In some embodiments, the processor extracts features from the response data, generates one or more models using the extracted features, and generates the predicted ratings using a selected model of the one or more models.

In some embodiments, the system has one or more cameras or sensors to generate the response data.

In another aspect, embodiments described herein provide a computer system for natural language processing for quality assurance of rating data and assessing response data for constructed-response tests. The system has: a memory, and a processor coupled to the memory programmed with executable instructions, the instructions including an interface for obtaining rating data and response data for a constructed-response test, wherein the processor executes the instructions to provide a natural language processing engine for sentiment analysis and unsupervised text classification to generate predicted rating data for the response data for the constructed-response test, wherein the processor compares the predicted rating data to the rating data and generates quality assurance data based on results of the comparison. The system has a memory, a processor coupled to the memory programmed with executable instructions, the instructions including an interface for obtaining response data for a constructed-response test, wherein the processor executes the instructions to provide a natural language processing engine to generate predicted rating data for the response data and generates quality assurance data based on the comparison using one or more models, wherein processor using the one or more generative models to generate feedback data about the response data, wherein the quality assurance data comprises the feedback data. The system has an examinee electronic device for collecting the rating data for the response data for the constructed-response test, the device having a transceiver for transmitting the collected response data to the interface. The system has a rater electronic device for collecting the rating data for the response data for the constructed-response test, the electronic device having a transceiver for transmitting the collected rating data to the interface, wherein the processor compares the predicted rating data to the rating data and generates additional quality assurance data about the rating data based on results of the comparison using the one or more models.

In some embodiments, the processor uses the natural language processing engine for the unsupervised text classification to categorize the response data based on similarities between the response data and one or more topics for the constructed response test.

In some embodiments, the processor determines alignment between the one or more topics for the constructed response test, the response data, and the rating data to compute precision and recall for the one or more topics for the constructed response test.

In some embodiments, the processor uses the natural language processing engine for the unsupervised text classification to assign labels or categories to the response data and evaluate alignment between the assigned labels or categories and one or more topics or aspects of the constructed response test.

In some embodiments, the processor uses the natural language processing engine for the sentiment analysis to compute sentiment and subjectivity scores for the response data.

In another aspect, embodiments described herein provide a computer process for natural language processing for quality assurance of rating data and assessing response data for constructed-response tests. The process involves a processor coupled to memory programmed with executable instructions including an interface for obtaining rating data and response data for a constructed-response test, wherein the processor executes the instructions to provide a natural language processing engine. This cumulates in: generating, using the response data, combined response data for multiple questions for a scenario of the constructed-response test; extracting features from the combined response data; generating training data set and testing data set from the features; developing, training and validating one or more models using the training data; selecting a model from the one or more models; generating predicted ratings using the testing data set and the selected model; generating quality assurance data by comparing the predicted ratings to the rating data; transmitting the quality assurance output data to an electronic device for display or storing the quality assurance and feedback data output data in the memory; generating predicted rating data for the response data and generating quality assurance data based on results of the comparison using one or more models.

In another aspect, embodiments described herein provide a computer process for natural language processing for quality assurance of rating data and assessing response data for constructed-response tests. The process comprises: by a processor coupled to memory programmed with executable instructions, the instructions including an interface for obtaining rating data and response data for a constructed-response test, wherein the processor executes the instructions to provide a natural language processing engine, implementing sentiment analysis and unsupervised text classification to generate predicted rating data for the response data and assesses the response data for the constructed-response test, generating quality assurance data by comparing the predicted rating data to the rating data and using one or more generative models to generate feedback data about the response data, and transmitting the quality assurance data and feedback data to an electronic device for display.

In a further aspect, embodiments described herein provide a computer system for natural language processing for quality assurance of rating data and assessing response data for constructed-response tests. The system involves: a memory, and a processor coupled to the memory programmed with executable instructions, the instructions including an interface for obtaining rating data and response data for a constructed-response test. The processor executes the instructions to provide a natural language processing engine to generate predicted rating data and feedback data for the response data for the constructed-response test. The processor compares the predicted rating data to the rating data and generates quality assurance data based on results of the comparison.

In another aspect, embodiments described herein provide a computer system for natural language processing for quality assurance of rating data and assessing response data for constructed-response tests. The system involves a memory, and a processor coupled to the memory programmed with executable instructions including an interface for obtaining rating data and response data for a constructed-response test. The processor executes the instructions to provide a natural language processing engine for sentiment analysis and unsupervised text classification to generate predicted rating data and feedback data for the response data for the constructed-response test. The processor compares the predicted rating data to the rating data and generates quality assurance data based on results of the comparison.

In accordance with an aspect, there is provided a computer system for natural language processing for quality assurance of rating data and assessing response data of constructed-response tests. The system has a memory, and a processor coupled to the memory programmed with executable instructions including an interface for obtaining rating data for response data for a constructed-response test, wherein the processor executes the instructions to provide a natural language processing engine to generate a predicted rating for the response data for the test and compare the predicted rating to the rating data for quality assurance. The system has a memory, and a processor coupled to the memory programmed with executable instructions including an interface for obtaining response data for a constructed-response test, wherein the processor executes the instructions to provide a natural language processing engine to generate a predicted rating data for the response data and generates quality assurance data based on results of the comparison using one or more models, wherein processor using the one or more generative models to generate feedback data about the response data, wherein the quality assurance data comprises the feedback data. The system has an examinee electronic device for collecting the response data for the test, the device having a transceiver for transmitting the collected response data and feedback data to the interface. The system has a rater electronic device for collecting the rating data for the response data for the situational judgement test. The electronic device having a transceiver for transmitting the collected rating data and response data to the interface.

Many further features and combinations thereof concerning embodiments described herein will appear to those skilled in the art following a reading of the instant disclosure.

### DESCRIPTION OF THE FIGURES

Systems, devices, aspects, methods, and results are described in greater detail herein with reference to the following figures in which:

FIG. 1 shows an example system for natural language processing for quality assurance for constructed-response tests.

FIG. 2 shows an example method for natural language processing for quality assurance for constructed-response tests.

FIG. 3A shows another example method for natural language processing for quality assurance for constructed-response tests.

FIG. 3B shows an example method for natural language processing for assessing response data for constructed-response tests.

FIG. 3C shows an example aspect of a method for natural language processing for assessing response data and generating feedback data.

FIGS. 4A and 4B shows example results as distributions of subjectivity and sentiment scores by scores assigned by human raters for the illustrative example study.

FIG. 5 shows another example system for natural language processing for quality assurance for constructed-response tests.

FIG. 6 is a schematic diagram of computing device that can be used to implement aspects of embodiments described herein.

FIG. 7 shows a table of examples aspects of professionalism for the tests, and corresponding keywords.

FIG. 8 shows a table of example results for text classification.

### DETAILED DESCRIPTION

Embodiments described herein relate to systems and methods for natural language processing for quality assurance of rating data (i.e. data assessing how raters themselves are reviewing test-taker's responses) and assessing response data (i.e. the test-taker's input in response to questions) for constructed-response tests that can involve different types of assessments to measure non-cognitive skills (including but not limited to professionalism, situational awareness, social and emotional intelligence) using constructive open responses. Multiple test-takers may be taking the same test, and each test-taker's individual response data may be assessed by the same or different raters, or response data may be automatically assessed using one or more Large Language Models (LLMs) (e.g. generative artificial intelligence (AI)).

Another example test to measure non-cognitive skills is an SJT, or similar tests that measure various non-cognitive skills based on examinees' actions for hypothetical real-life scenarios. To ensure the validity of scores obtained from SJTs (or constructed response tests), embodiments described herein provide for a quality assurance (QA) framework. Another example constructed-response test may relate to emotional intelligence that can be evaluated using different rubrics or assessment tools. The QA framework can involve automatically assessing response data for constructed-response tests using one or more LLMs, and generating predicted rating data of ratings or scores (or values) as a metric or valuation or estimation of correctness of the response data. The QA framework can also involve generating feedback data about the response data using one or more generative models to evaluate the response data and generate feedback content. The quality assurance data can include feedback data about the response data. For example, the feedback data can provide feedback about the response data to help identify areas of improvement. The quality assurance data can include feedback data about the automated or predicted rating data. For example, the feedback data can assess the quality of the automated or predicted rating data to evaluate if the automated or predicted rating data is accurate or valid. The feedback data can evaluate the rating data to provide feedback on the rating data. The QA framework can use different rubrics or assessment tools to evaluate the response data and generate the predicted rating data. The QA framework can involve automated comparisons, LLMs, rubrics, automated scoring, narrative analysis, feedback, formative assessments, and so on. The generative models may be used to automatically assess response data for the constructed-response tests, and may generate feedback content to provide feedback to the test takers regarding their response data. Embodiments described herein can generate rating data for the response data, such as a score, using AI. Embodiments described herein can generate feedback data which can include text data for a narrative to give feedback to the test-taker about the response data. Embodiments described herein use LLMs with rubric, automated scoring, narrative analysis, feedback, formative assessment, and so on. The QA framework can provide real-time or near real-time predicted ratings or feedback on the response data. The QA framework can provide real-time or near real-time feedback on the quality or accuracy of the predicted rating data.

An example embodiment of automatically assessing response data for constructed-response tests using one or more LLMS (as a replacement of human ratings) can involve a formative situational judgement test. For example, a test can assess different dimensions of social and emotional intelligence, including for example: perceiving (reading the situation), understanding (how it affects you), managing (effective interacting), and using (resolution enactment). As an example, test-takers can be presented with a visualization of a question stem showing a scenario to be experienced by the test-taker (i.e. through an SJT) and can be written, a video, or 3D immersive. For any individual item stem, the test-taker can be presented different questions reflecting different dimensions of social and emotional intelligence. In some examples, test-takers can be shown a maximum number of questions per dimension for any one question stem. The test-taker's response may be written (typed), audiovisual, or auto-transcribed from the audiovisual. There can be multiple test takers, each providing individual response data. System 100 can output an AI generated score and narrative description of each test-taker's individual performance, their social intelligence strengths and weaknesses. System 100 can generate the output from the test-taker's open-ended responses. Scores can be aggregated across each dimension to calculate a final score for each dimension for overall performance on the test. The AI generated scores and narrative can be driven by different example approaches, such as: (1) previously used items with human rated scores sufficient in number to provide LLMs, (2) new items using AI (e.g. NLP Engine 122) agnostic to scenario specifics, and/or (3) new items using AI (e.g. NLP Engine 122) which works in a scenario-specific fashion. Other example rubics include measurements or evaluations of whether a test taker effectively read the situation presented or whether a test taker demonstrated how a dilemma affected them. Embodiments described herein can provide computer systems and methods configured to automatically assess response data for different kinds of assessments or tests using one or more LLMs. Example assessments or tests include formative or summative assessments. In some embodiments, the tests can relate to different dimensions, such as an assessment of critical thinking or ethical judgement, or dimensions that are unrelated to unrelated to social or emotional intelligence such as measures of writing quality including cohesiveness and vocabulary use.

In particular, some embodiments described herein relate to computer systems and methods that leverage NLP to build an efficient and effective QA framework for evaluating scores or ratings of constructed-responses from assessments or tests focusing on different aspects of professionalism, social intelligence, or non-cognitive skills. In some embodiments, the systems and processes for natural language processing for quality assurance of constructed-response tests or open response tests to measure various cognitive skills. In another aspect, embodiments described herein relate to computer systems and methods that leverage NLP and LLMs to build an efficient and effective QA framework for evaluating response data from assessments or tests. Embodiments described herein have the ability to provide some combination of scores, automated narrative analysis, and feedback to test takers. In some embodiments, system 100 automatically generates feedback data that evaluates the response data which can include text or narrative about the evaluation of the response data and areas for improvement along with recommendations.

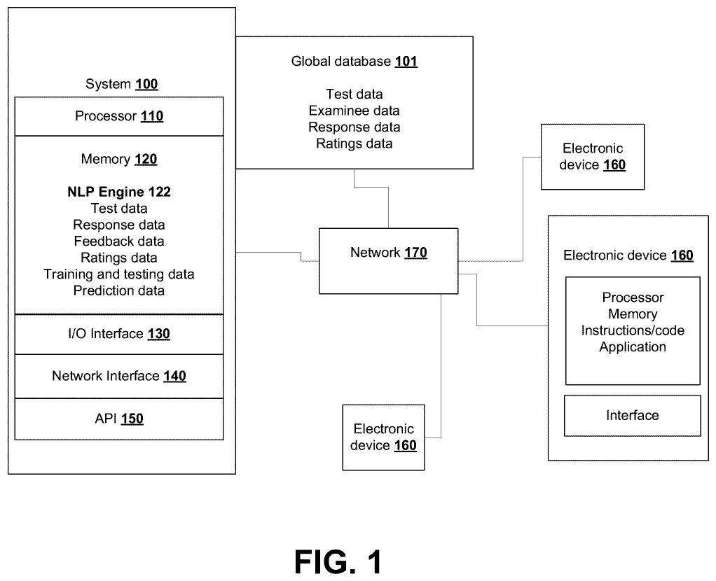

FIG. 1 shows an example system 100 for NLP for quality assurance of constructed-response tests. For example, the system 100 can use NLP to automatically examine the impact of the tone of input data extracted from e.g. written responses human raters' scoring, and alignment between intended aspects of professionalism and the aspects extracted from written responses. As another example, the system 100 can use NLP to automatically examine the response data to automatically generate feedback data about the response data and to automatically generate (predicted) rating data (e.g. scoring) of the response data. The predicted rating data can comprise automatically generated scores of the response data as estimations or evaluations of the accuracy or correctness of the response data for the test. A constructed-response test can involve video-based or written scenarios. A constructed-response test has corresponding constructed-response items. Examinees can either watch a video or read a scenario and then respond to a set of constructed-response items associated with the scenario. In each scenario, multiple aspects of professionalism can be measured. Embodiments described herein relate to computerized, online test designed for assessing different aspects of professionalism and social intelligence such as collaboration, communication, equity, ethics, empathy, motivation, problem-solving, self-awareness, and resilience. An example test is an SJT.

However, scoring responses for constructed-response tests generally involve human judgement by human raters which can create quality assurance challenges. Other factors such as examinees' writing ability (or lack thereof) may also influence how they respond and subsequently how human raters interpret and score those responses. With open responses, Examinees are not required to speak directly to any of the aspects underlying the tests. While this provides freer expression, how the responses from each applicant relate to the targeted aspects of professionalism remains in question. Further, psychometric procedures designed for multiple-choice questions and rating scales are not suitable for some tests (e.g., SJTs). Written responses cannot be examined based on conventional psychometric methods. Embodiments described herein provide a system 100 for NLP for quality assurance of constructed-response tests that leverage NLP methods and models to automatically evaluate and validate written responses (e.g. response data), and/or associated scores or ratings. In some embodiments, the system 100 can use NLP to automatically generate rating data (e.g. scoring) of the response data and to automatically generate feedback data about the response data. In some embodiments, the system 100 can use NLP to automatically evaluate rating data (e.g. scoring) of the response data and to automatically generate feedback data about the rating data. The system 100 can use a quality assurance framework that automatically considers whether subjectivity and tone of written responses affect scores assigned by human raters. System 100 can automatically assess response data for constructed-response tests using one or more LLMs, and generate predicted rating data of ratings or scores (or values) as a metric or valuation or estimation of correctness of the response data. System 100 can automatically generate feedback data about the response data using one or more generative models to generate text output that describes the evaluation of the response data to generate feedback content for display at an examinee device. The quality assurance data can include feedback data about the response data. For example, the feedback data can provide feedback content that identifies areas of improvement or provides recommendations for improvement or knowledge development. Accordingly, the feedback data can be about the examinee and can help the examinee improve or develop knowledge or skills. The quality assurance data can include feedback data about the automated or predicted rating data. For example, the feedback data can assess the quality of the automated or predicted rating data to evaluate if the automated or predicted rating data is accurate or valid. The feedback data can evaluate the rating data to provide feedback on the rating data. Accordingly, in some embodiments, the feedback data can be about the system 100 and its ability to accurately generate predicted rating data. System 100 can use different rubrics or assessment tools to evaluate the response data and generate the predicted rating data. System 100 can use automated comparisons, LLMs, rubrics, automated scoring, narrative analysis, feedback, formative assessments, and so on. The generative models may be used to automatically assess response data for the constructed-response tests, and may generate feedback content to provide feedback to the test takers regarding their response data. System 100 can generate rating data for the response data, such as a score. Embodiments described herein can generate feedback data which can include text data for a narrative to give feedback to the test-taker about the response data. System 100 can provide real-time or near real-time predicted ratings or feedback on the response data. System 100 can provide real-time or near real-time feedback on the quality or accuracy of the predicted rating data.

The system 100 can process input data using NLP engine 122 to generate output data. The output data can be rating data or scoring of the response data, and feedback about the response data. The output data can be an assessment of rating data (e.g. human rating data) and feedback about the rating data. The system 100 can use different types of models for NLP engine 122, such as, for example, LLMs (e.g., GPT-4, PaLM, BLOOM, LLaMA, BERT, Falcon, Claude, Mistral) to evaluate responses for specified criteria (such as those from a rubric) including whether the response considered multiple perspectives, provided a justification, displayed resilience, indicate that the test taker effectively read the situation, or demonstrated how a dilemma affected them. System 100 can update to use different LLMs. The system 100 can train one or more models for NLP engine 122. The system 100 can operate without any human-labeled data for training or it can use a small set of human-labeled data (<10 positive examples per rubric criteria) to improve the specificity of its results to the particular test and rubric criteria used.

The system 100 can return output in various formats (or a combination of formats) for display at interface such as a bulleted list of whether the response addressed each of the specified criteria, constructive feedback including positive reinforcement, or a numeric score (with any scale). The interface can have one or more visual elements that can be modified based on the output data to visually update the interface (e.g. displayed at an electronic device). The output format can be specified based on the needs of the end-user and the capabilities of the interface at its electronic device. Example end-users could include evaluators, teachers, and students. The system can further aggregate its output across multiple constructed-response items in a given test or across multiple tests to identify the most salient evaluations with respect to the provided criteria.

The system 100 can use a quality assurance framework that considers whether written responses for each scenario accurately reflect the aspects of professionalism underlying the test. The system 100 can evaluate rater data for the written responses to automatically assess whether the rater data is accurate. The system 100 can evaluate the written responses to automatically assess or score the response data (e.g. generate rater data) and feedback content about the response data.

A test can involve multiple scenarios. Each scenario can be associated with testing one or more professionalism and social intelligence aspects (e.g., communication, empathy, equity, and ethics). Each scenario can be associated with one or more questions, and corresponding response items for the questions. A scoring or rating can be generated by combining scores or ratings for responses to questions relating to each scenario. As an example, responses to questions for each scenario can be assigned a rating or score between 1 (lowest) and 9 (highest). The system 100 can use a corpus for NLP of written responses to multiple scenarios. The corpus of written responses can be used for training one or more models of NPL engine 122, for example.

By processing written responses (e.g., constructed-response items) from an operational constructed-response test, system 100 can perform sentiment analysis to automatically assess if the tone of written responses affects scores assigned by human raters. System 100 can automatically compare the results of its sentiment analysis to scores assigned by human raters captured as rating data. Furthermore, system 100 can implement unsupervised text classification to evaluate the extent to which written responses reflect the theoretical aspects of professionalism underlying the test and automatically generate rating data (e.g. scoring) of the response data and automatically generate feedback about the rating data and/or response data. System 100 uses NLP engine 122 for an efficient and effective automated QA process to evaluate human scoring or rating data and collect validity evidence supporting the inferences drawn from operational constructed-response test scores.

The system 100 has at least one processor 110 and memory 120 storing instructions for an NLP engine 122, the instructions being executable by the processor 110. The memory 120 stores different datasets for system 100, such as test data, examinee data, response data, and human ratings. The system 100 connects to an external global database 101 storing additional datasets, such as test data, examinee data, response data, feedback data, (human) rating data, and predicted rating data. The global database 101 can receive data from multiple systems 100 and aggregate the data for subsequent access by one or more systems 100. For example, the external global database 101 can store copies of the local data stored in the memory 120 of each system 100. The global database 101 can be distributed across multiple storage devices in some embodiments. Further, there can be multiple distributed systems 100 connected via network 170, and each system can provide datasets to global database 101 (or one or more distributed storage devices), and/or database(s) stored in its memory 120. For simplicity only one system 100 is shown, but there may be multiple systems 100 to access network resources, execute code to process data, and exchange data with other components. As an illustrative example test, embodiments are described herein with reference to an SJT. However, embodiments described herein can be used for different types of constructed-response tests that measure or assess professional or non-cognitive skills using constructive, open responses. The system 100 can use one or more datasets to train models for NLP engine 122 in some embodiments.

In some embodiments, the systems and processes for natural language processing for quality assurance of rating data and assessing response data of constructed-response tests or open response tests to measure various cognitive skills. The system 100 can use one or more datasets to train models for NPL engine 122 for different types of testing in various embodiments.

The system 100 includes at least one processor 110, memory 120, at least one I/O interface 130, at least one network interface 140, and an application programming interface (API) 150. The I/O interface 130 enables system 100 to interconnect with one or more input devices, such as a keyboard, mouse, camera, touch screen and a microphone, or with one or more output devices such as a display screen and a speaker. The network interface 140 enables system 100 to communicate with other components, to exchange data with other components, to access and connect to network resources, to serve applications, and perform other computing applications by connecting to a network 170 (or multiple networks, or a combination of different networks) capable of carrying data. The hardware components of system 100 may be connected in various ways including directly coupled, indirectly coupled via a network, and distributed over a wide geographic area and connected via a network (which may be referred to as “cloud computing”). For example, and without limitation, the system 100 may be a server, network appliance, embedded device, computer expansion module, or other computing device capable of being configured to carry out the methods described herein.

The system 100 connects to electronic devices 160 to exchange data. An electronic device 160 can have memory storing instructions for applications and one or more processors that execute the instructions and applications. The memory can store instructions for an interface to provide and receive data. For example, an examinee can use an electronic device 160 for SJTs or constructed-response tests. The electronic device 160 has an interface to provide SJT data to the examinee and collect response data for the SJT. As another example, a rater can use an electronic device 160 for rating response data for SJTs. The electronic device 160 has an interface to provide response data and SJT data, and collect rating data. The electronic device 160 has an interface with one or more visual elements that update based on the output data to visually modify the interface. The system 100 can control visual elements of the interface based on the output data.

As an illustrative example, post secondary education programs (e.g., medical schools) can require SJTs (or other types of constructed-response tests) to evaluate applicants' knowledge and non-cognitive skills (including but not limited to professionalism, situational awareness, social intelligence, and other non-academic areas), or in some embodiments, cognitive skills. In SJTs, applicants can be asked to review a series of hypothetical real-life scenarios and then describe the course of action they are likely to take in open (or constructive) response format. The system 100 can provide an online constructed-response test that consists of video-based and text-based scenarios focusing on multiple aspects of non-cognitive skills (e.g., professionalism) based on different frameworks (e.g., CanMEDS framework) defining key competencies (e.g., collaboration and communication) for different types of professions (e.g., health professions). Accordingly, input data for system 100 can include video data, text data, image data, audio data, metadata for the online constructed-response test (e.g. timing data, location data, system data, interface data), and so on. Further example details on testing with video and audio response data are provided in International Patent Application no. PCT/CA2022/051301 the entire contents of which is hereby incorporated by reference. Examinees of constructed-response tests according to embodiments described herein can receive a set of questions associated with each scenario and submit responses to each question. Accordingly, the constructed-response test can involve a set of questions for a respective scenario and a corresponding set of responses. Therefore, unlike multiple-choice or rating questions in traditional SJTs, the system open response format allows examinees to draw from their own experiences and use their own words to describe what actions or decisions they would take for each scenario and their rationale for doing so.

An example SJT can relate to a formative assessment which tests a specific model and definition of professionalism and social intelligence, that is a student's ability to affectively reflect on and communicate responses to interpersonal and professional dilemmas using critical reasoning and social interpretation. The formative assessment scenarios were constructed to include content that is interpretable equally in all of the different aspects of professionalism and social intelligence. Analysis of responses to specific scenarios provides an indication of an individual's ability to apply professionalism and social intelligence in complex situations and choose a response when faced with a dilemma. The formative assessment also tests student's ability to perform Entrustable Professional Activities, key tasks of a discipline that a practitioner (in this case a medical professional) needs to be able to perform, related to professionalism and social intelligence.

Although the use of open response questions has advantages, it also creates technical challenges that need to be addressed to obtain reliable and valid test scores from the system 100. For example, scoring or rating responses may involve human judgment. Raters from various backgrounds and professions review underlying theory and guiding statements for each scenario and then rate answers or responses to each scenario holistically. Electronic devices 160 operated by raters can display response data for a constructed-response test, collect rating data, and transmit the rating data to system 100. These scores or ratings are expected to vary based on the difficulty levels of questions and examinees' ability levels in the aspects being measured by system 100 and the constructed-response test. However, other factors such as examinees' writing ability (or lack thereof) along with their interpretation of each scenario may also influence how they respond and subsequently how the human raters interpret and score those responses. Also, while answering the questions in a constructed-response test of the system 100 (e.g., using electronic device 160 to display constructed-response test data and collect response data), examinees are not required to speak directly to any of the aspects underlying the constructed-response test and system 100. While this provides freer expression or a flexible form of expression, how the responses from each applicant relate to the targeted aspects of the non-cognitive skills may remain in question.

To ensure the correct interpretation and use of scores, system 100 implements a QA process using an NLP engine 122 for automatically evaluating the content, response data, internal structure, and response processes. Research shows that psychometric procedures designed for multiple-choice and rating questions may be less suitable for constructed-response tests. The system 100 can use constructed-response test that involve long written open responses from large numbers of examinees, which cannot be examined based on conventional psychometric methods. Thus, embodiments described herein aim to provide a new QA process and system for evaluating constructed-response test scores efficiently using language processing tools (e.g., NLP engine 122). The outcomes of this system can increase the interpretive value of the constructed-response test responses, while enhancing rater training and feedback process by using generative models to automatically generate feedback data. The feedback data can be used for feedback content to provide to the applicants in relation to their response data. Embodiments described herein can be used for QA and other applications, such as automated scoring (for an NLP replacement of human ratings) or hybridization with human ratings. System 100 leverages NLP engine 122 to automatically evaluate and validate written responses to the constructed-response tests provided by system 100. Embodiments described herein involve a new analysis process to answer the following example questions: 1) Do the subjectivity and tone of written responses affect scores assigned by human raters? 2) Do written responses to questions for each scenario accurately reflect the aspects of non-cognitive skills underlying the constructed-response test?

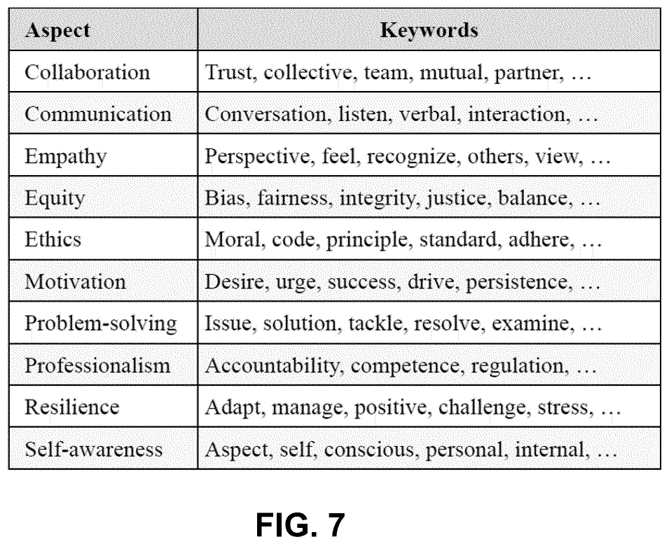

A variety of test-related tasks can be implemented using NLP engine 122 such as automatic text summarization, automatic item generation, automated essay scoring, and topic modeling. NLP engine 122 can be implemented by a hardware processor executing code or instructions for NLP processes. In example embodiments, system 100 can employ one or more unsupervised text classification methods (e.g., Lbl2Vec, and BERTopic) to categorize written responses for constructed-response tests provided by system 100 into the aspects of non-cognitive skills such as professionalism. Unlike topic modeling that clusters documents based on word (or phrase) patterns and identifies latent topics, the unsupervised text classification method (e.g., Lbl2Vec) categorizes documents based on semantic similarities between the documents and predefined keywords representing a topic or aspect of professionalism. In some embodiments, system uses document embeddings such as DOC2Vec, Ada, Universal Sentence Encoder, and SBERT by way of illustrative example. FIG. 7 shows examples of different aspects of professionalism for the tests, and corresponding keywords. After transforming a document into word and document embeddings, the NLP engine 122 calculates the centroid of embeddings for each predefined topic and then calculates the cosine similarity to find the most relevant topic for each document. In this example, NLP engine 122 can use Lbl2Vec to categorize examinees' written responses (captured as response data by system 100) into the different aspects of non-cognitive skills (such as professionalism) underlying the particular constructed-response test.

The system 100 can also conduct sentiment analysis to check or compute the subjectivity and sentiments of written responses for the constructed-response tests of system 100. In lexicon-based approaches, sentiments within a document can be calculated using the number of words classified as either positive or negative based on a pre-defined dictionary. To calculate sentiment scores (ranging from 0 to 1 where 0 is negative and 1 is positive), in an example embodiment, system 100 can utilize VADER in Python, which is sensitive to both the polarity and the intensity of sentiments as it takes negations (e.g., not good) and degree modifiers (e.g., very) into account. System 100 can also utilize Flair, Stanza, or an LLM (e.g., GPT-4, PaLM, BLOOM, LLaMA, BERT, or Falcon) to calculate sentiment scores. These are example LLMs and other LLMs can be used in different embodiments. For subjectivity, in some example embodiments, the system can use TextBlob, which calculates a subjectivity score based on the number of personal opinions and factual information shared in the document. Subjectivity ranges from 0 to 1 where 0 is very objective and 1 is very subjective.

The system 100 can use a corpus for NLP engine 122. As an illustrative (non-limiting) example study, a corpus can consist of anonymized written responses (e.g., a number of responses such as 635 or 106) to questions for multiple unique scenarios (e.g., 311 scenarios) for constructed-response tests of system 100. Based on the content underlying the scenarios, subject matter experts (SMEs) can categorize the scenarios into one of the ten intended non-cognitive skill (e.g., professionalism) aspects. During test administration, examinees provide written responses to multiple questions related to each scenario and receive a rating or score on a scale (e.g., between 1 and 9). In this example, the system 100 can combine examinees' responses to multiple questions associated with each scenario as a single text and processes them together.

The system 100 can use NLP engine 122 to rate different types of assessments for feedback purposes (“formative assessments”). Unlike assessments conducted for decision-making purposes (“summative assessments”), formative assessments may not require a significant degree of human rater use and can be entirely rated by NLP engine 122 in some embodiments. Formative assessment use cases include, but are not limited to: feedback provision to assessment-takers (often trainees, but not limited to trainees); serial use of assessments over time to allow graphs of progress over time, including slope of the curve; use of individual data to incorporate into building of each trainee's summative letter provided by the Dean's office at completion of the program; provision of same data to trainee supervisors/mentors to facilitate guidance of trainees; provision of aggregate data to Student Affairs chair to better understand prospective resource requirements; and, anonymized aggregate data, including over time with slope of curve, to programs to facilitate circular review and program review. These are illustrative (non-limiting) examples.

There are a set of typical ways that individuals will think through a softer skills challenge. Some may rely more upon an ethical approach, some more upon resilience, and so on. The degree to which an individual relies upon one approach, or heuristic, compared to others, can be determined using NLP engine 122 to review the assessment responses. This may not measure how well the individual does in their approach; it just maps out the extent to which they tend to use that approach. This map can be displayed in spider graph or other graphical method at an interface. The results can also be compared against program tendencies/preferences, or subprogram components tendencies/preferences, to determine strength of alignment between each individual and the training program, or components thereof. Further details of the methods used to calculate strength of alignments can be found at U.S. patent application Ser. Nos. 17/971,444 and 17/451,724 the contents of which are hereby incorporated by reference.

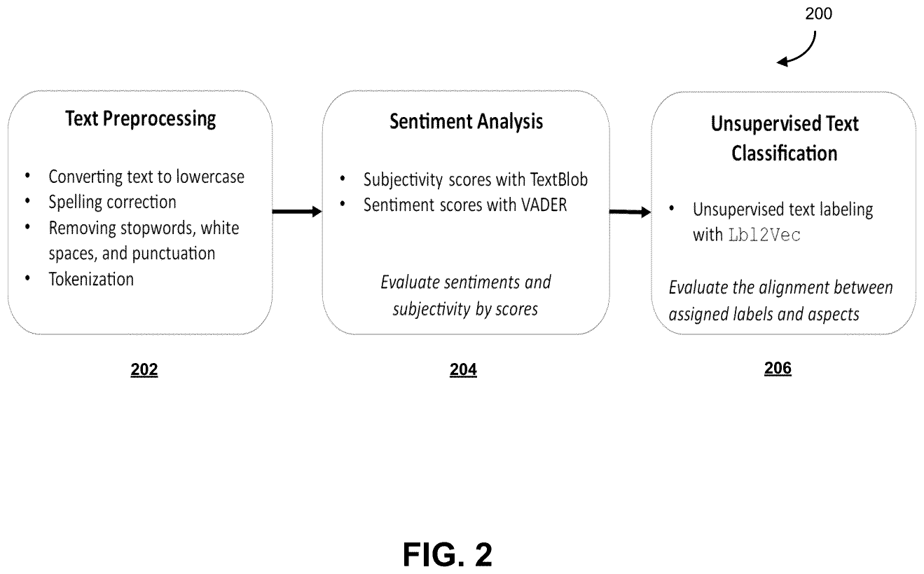

FIG. 2 shows an example method 200 for natural language processing for quality assurance for constructed-response tests by processing response data for constructed-response tests. The system 100 uses its hardware components to implement method 200 in example embodiments.

As an illustrative example, the method 200 can involve multiple steps 202, 204, 206 to process response data. At 202, system 100 performs text preprocessing to prepare the response data. At 204, the system 100 conducts sentiment analysis, computes polarity and subjectivity scores, and evaluates the relationship between sentiment scores and scores assigned by human raters. Sentiments expressed through the responses might not have any relationship with the scores, or sentiments of responses may have a relationship with the ratings. At 206, system 100 uses unsupervised text classification to categorize written responses into one of the ten aspects of professionalism based on predefined keywords obtained from the QA process (e.g., CanMEDS framework). Then, system 100 compares the aspects assigned by the unsupervised text classification method (e.g., Lbl2Vec) with the intended aspects or ratings assigned by the subject matter experts or raters for each scenario. The system evaluates the alignment between the assigned labels and the aspects or ratings assigned by the subject matter experts or raters for each scenario. This allows system 100 to determine whether written responses are related to the intended aspects underlying the scenarios.

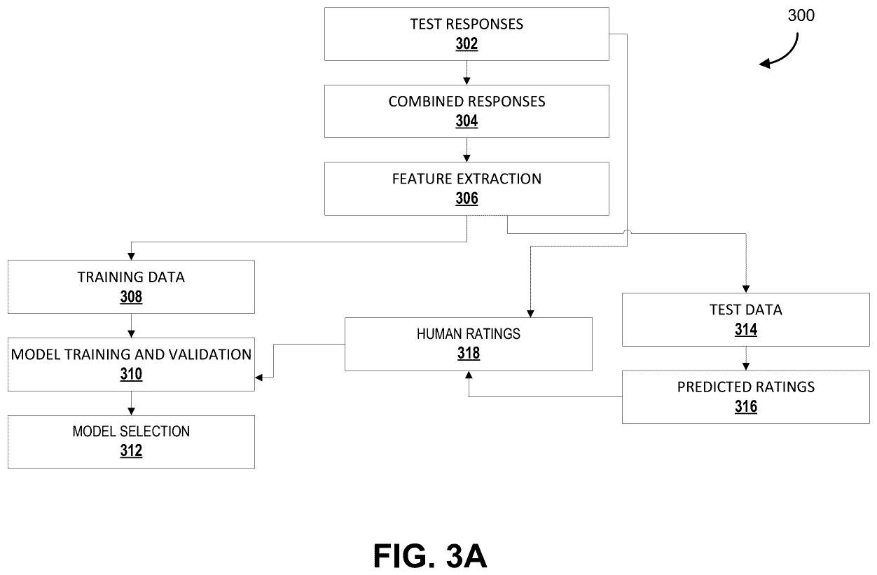

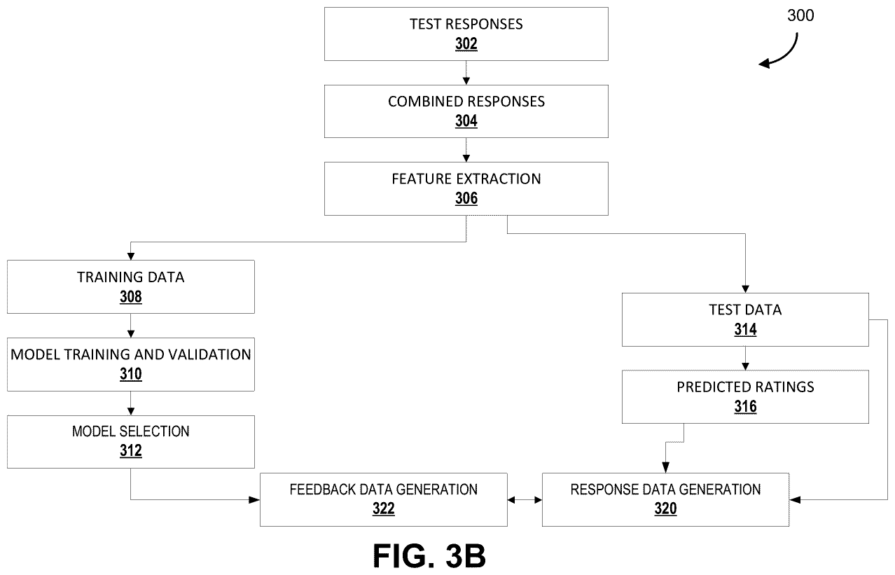

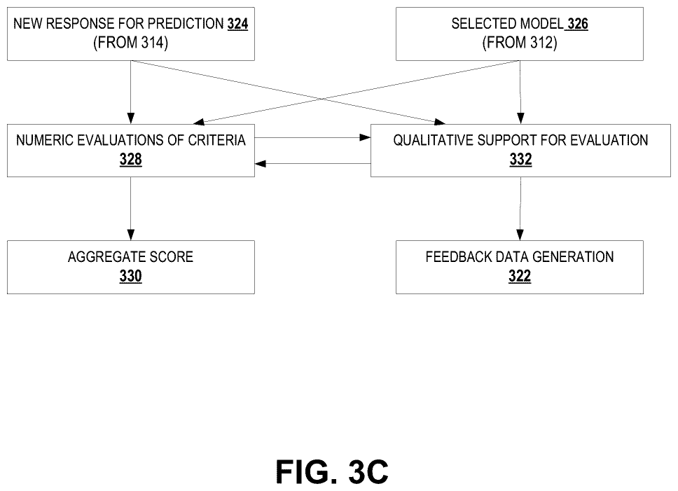

FIGS. 3A and 3B show another example method 300 for natural language processing for quality assurance for constructed-response tests by analyzing response data for constructed-response tests. FIG. 3C shows an example aspect of method 300 for assessing response data and generating feedback data. The system 100 uses its hardware components to implement method 300 in example embodiments.

The system 100 can transmit constructed-response test data to electronic devices 160 operable by examinees of constructed-response tests. For example, system 100 can involve a plurality of examinee devices (e.g. electronic devices 160). The electronic devices 160 operable by examinees have an interface to display test data and collect response data for the constructed-response test. The electronic devices 160 transmit the response data to system 100. The response data can be tagged with an identifier for a specific electronic device 160 or examinee. In some embodiments, at 302, the system 100 receives response data from electronic devices 160 operable by examinees of constructed-response tests.

In some embodiments, at 302, system 100 transmits response data to electronic devices 160 for scoring or rating by human raters. In some embodiments, at 302, system 100 stores the response data for automated scoring or rating, to generate feedback data, for aggregation with other response data, and so on. System 100 can process stored response data. System 100 can store the response data in memory 120 in association with the identifier for the specific electronic device 160 or examinee that the response data was received from.

In some embodiments, at 318, human rating data is received at system 100. The rating data can be an aggregate (or combined) score or rating for multiple questions of the same scenario (e.g., rating/applicant/scenario). For example, a scenario may be associated with a set of questions and a corresponding set of responses. The rating data can be an aggregate score or rating of the set of responses to the set of questions for the respective scenario. That is, the scenario may be associated with a rating that represents (an aggregation or combination of) multiple ratings/scores for the responses to the questions for the same scenario. An applicant can be given a single holistic or aggregated score for a series of questions for the scenario.

At 304, system 100 combines response data for multiple (e.g., three) questions (e.g., q1, q2, q3) for each student for each scenario (i.e. q1+‘ ’+q2+‘ ’+q3) to generate combined response data. In some embodiments, system 100 can generate combined response data by combining response data for multiple questions, a single question, a subset of questions, different combinations of questions, and so on. System 100 can store the combined or aggregated response data in memory 120.

At 306, system 100 extracts features from the combined response data. The system 100 can use multiple features, different types of features, different combinations of features, different semantic relationships, and so on. As an illustrative example, different features can include lemma type-token ratios, lexical token and type density, lexical overlap between adjacent sentences, semantic overlap between adjacent sentences, keyword similarity with scenario prompts, questions, rater guiding questions, and rubrics, semantic similarity with scenario prompts, questions, rater guiding questions, rubrics, pre-trained document embeddings, and response sentiment and subjectivity. In some embodiments, the system 100 can use linguistic features and other types of features. System 100 can store the extracted features in memory 120.

At 308 and 314, system 100 splits features into training data sets (208) and testing data sets (214) based on point(s) in time. The system 100 can generate the training data sets and testing data sets using other indices, such as time, geographic location or professional field. For example, the system can construct a model using a training data set based on a set of data collected in a particular year (e.g., 2020) and the testing data set including all of the data collected after that year. System 100 can store the training data sets (208) and testing data sets (214) in memory 120.

At 310, system 100 develops, trains and validates one or more models using the training data. For example, model development can include testing a number of different models (linear regression, SVM, XGBoost) with 5-fold cross validation and hyperparameter tuning to optimize average cross-validated RMSE between predicted ratings and human ratings.

In some embodiments, training could also be used to optimize for other criteria independent of human raters. For example, system 100 can train a model to produce scores that align most closely with other measures of success such as interview scores during admission or grades while in-program. Accordingly, system 100 can develops, trains and validates one or more models for different criteria and objectives.

At 312, system 100 selects a model from the one or more models that were developed, trained and validated at 310. For example, system 100 can select the model with hyperparameters that produced the smallest average RMSE between predicted ratings and human ratings on the held-out dataset during cross-validation. In some example embodiments, the selected model can be an XGBoost model.

At 314, system 100 uses the test dataset and the selected (best) model to predict ratings (at 316) for the test dataset. That is, at 316, system 100 uses the test dataset (from 314) and the selected model (from 312) to generate predicted ratings. System 100 can compare the predicted ratings generated at 316 with the human rating data (received at 318) for the test data set to gauge expected model performance with future data or new data. System 100 can generate feedback data based on the predicted ratings generated at 316.

In some embodiments, system 100 de-personalizes or anonymizes the response data and aggregates the de-personalized (or anonymized) response data for automating program or curriculum review.

FIG. 3B shows another example embodiment for predicted ratings and feedback generation. System 100 generates predicted ratings (at 316) and corresponding feedback (at 322) for the response data. In some embodiments, the predicted ratings may be used by system 100 to automatically assess the response data (at 320). System 100 can generate predicted ratings and use the generated ratings to automatically evaluate the response data. This may be in addition to or as an alternative to the human rating data, in some embodiments. System 100 can use GenAI or LLMs to automatically generate feedback data (at 322) and to automatically generate predicted ratings (at 316) of the response data.

For example, system 100 can select one machine learning (ML) model (e.g., Xgboost, support vector machines, linear regressions, random forest models, or neural networks) at 312 for generating predicted ratings at 316. Aside from the ML model, in some embodiments, the system 100 can use several other python libraries (e.g., software code is written in python) for data processing and feature extraction before doing any actual modeling. In some embodiments, the system 100 can use spacy to perform lemmatization, part-of-speech tagging, and dependency parsing, pre-trained models from tensorflow hub (e.g., Bidirectional Encoder Representations from Transformers (BERT), Universal Sentence Encoder (USE)), or OpenAI (i.e. Generative Pre-trained Transformer) to produce document embeddings, and scikit-learn and tensorflow to train ML models such as support vector machines, linear regressions, random forest models, eXtreme Gradient Boosting (XGBoost) models, and neural networks.

FIG. 3C shows aspects of rating (or scoring) and feedback generation. At 324, system 100 identifies response data (from 314) for rating prediction. System 100 generates predicted ratings for the response data.

At 326, system 100 identifies the selected model (from 312).

System 100 uses the predicted rating (from 324) and the selected model (from 326) as input for numeric evaluation of criteria at 328. System 100 can use different rubics and evaluation models. At 330, system 100 generates an aggregate score. Aggregate scores can be obtained from a provided formula or by training a separate model to optimize scores according to different independent measure such as human rater scores or historically observed learner success metrics (e.g., course grades, supervisor evaluations).

System 100 uses the predicted rating (from 324) and the selected model (from 326) as input for qualitative support for evaluation at 332. System 100 generates feedback data at 322. Qualitative rationales may optionally be combined and/or reformatted into one or more pieces of feedback for delivery using a separate LLM.

System 100 can use the predicted rating data and the feedback data for one or more of identification of improvement areas, generation of individualized learning plans, curriculum reform, and monitoring. This information could be used by different end-users in different ways. Information provided to test takers could be used to identify areas for improvement and guide self-directed learning to address competencies related to social intelligence. Information provided to faculty or student affairs could be used to develop individualized learning plans for test takers and identify students who may be at risk of remediation for further monitoring and attention. Results can be used on aggregate to identify areas for improvement across a cohort of students, to guide curriculum reform, and to meet accreditation standards.

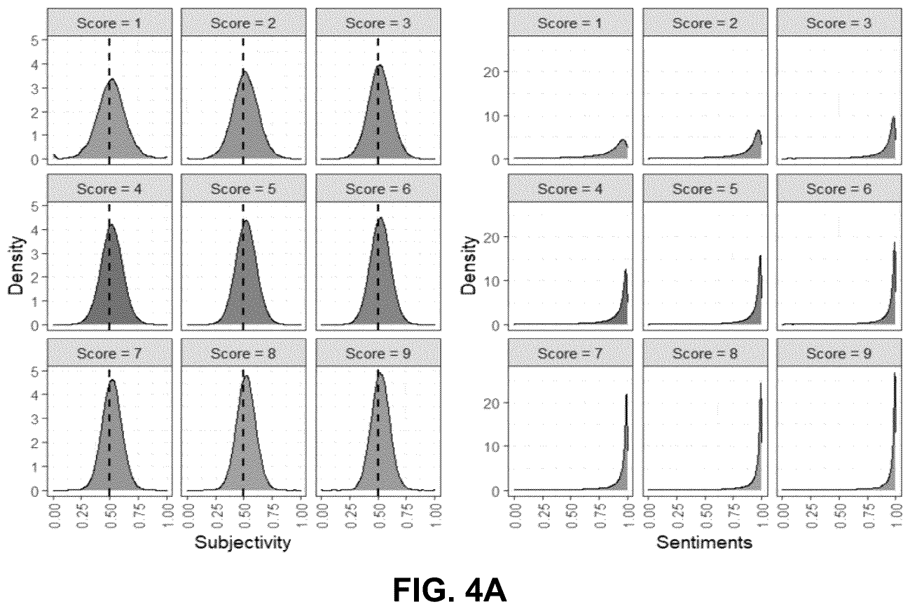

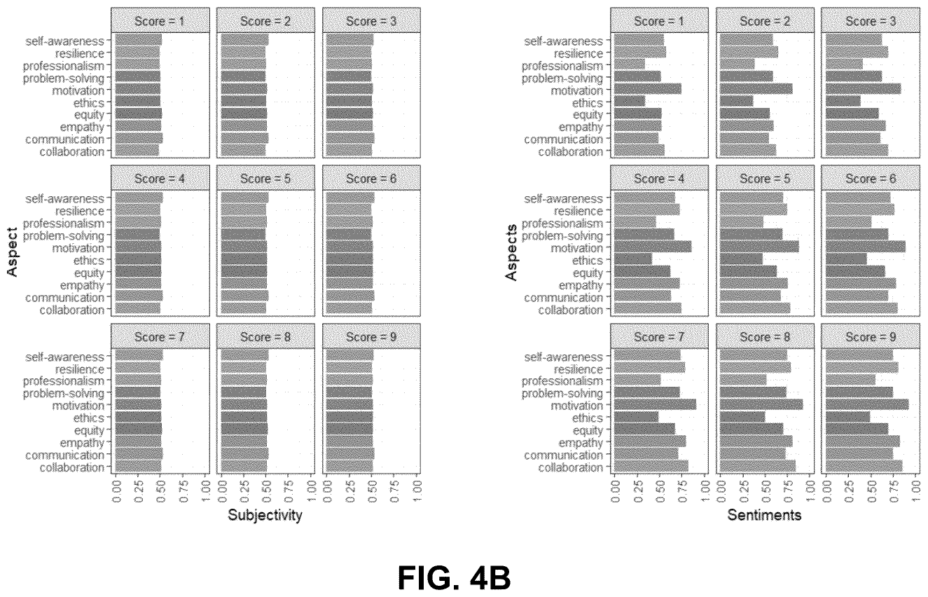

FIGS. 4A and 4B show example results as distributions of subjectivity and sentiment scores by scores assigned by human raters for an illustrative example. In the example shown in FIG. 4A, lower score categories (i.e., 1 to 3 points) have larger variation in subjectivity, indicating that examinees with very low or high subjectivity in their responses receive lower scores. Sentiment scores can indicate high levels of negative skew-ness for all score categories, suggesting that nearly all examinees in the sample dataset used a positive tone in their written responses, regardless of their scores. The examples shown in FIG. 4B indicate distributions for subjectivity and sentiments in relation to different aspects and corresponding scores.

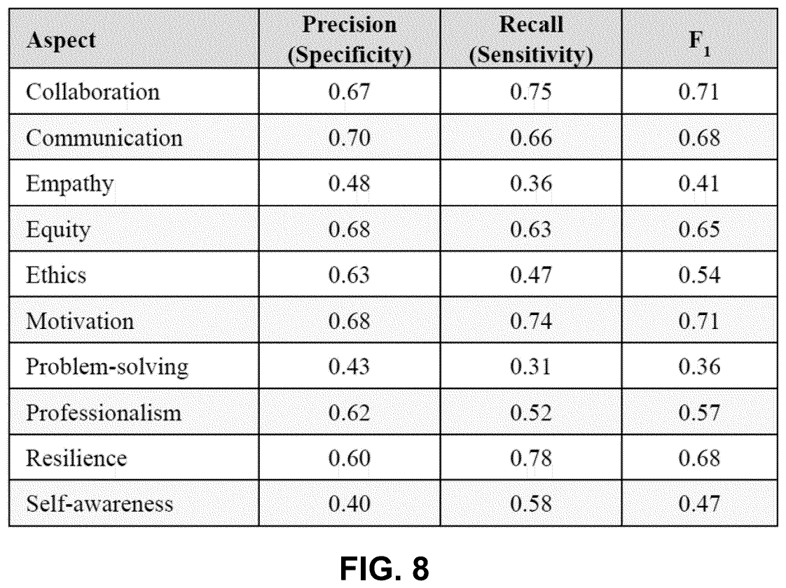

To evaluate the alignment between the aspects (or topics) of non-cognitive skills (e.g., professionalism) identified by SMEs and those assigned by the unsupervised classification process (e.g., Lbl2Vec), the system 100 can calculate precision as TP/(TP+FP) and recall using TP/(TP+FN) where TP is true positive, FP is false positive, and FN is false negative. Embodiments described herein can show that collaboration, communication, motivation, and resilience had high precision (around 0.76) and recall (around 0.70), whereas professionalism, ethics, and self-awareness were much more difficult to detect in the written responses. In some embodiments, system 100 can use unsupervised or semi-supervised text classification. FIG. 8 shows a table of example results for semi-supervised text classification. The table includes different aspects of professionalism for the test along with values for precision (specificity), recall (sensitivity), and an overall value.

In this illustrative example, system 100 demonstrates how to leverage NLP engine 122 to build an automated QA process for constructed-response tests (e.g., SJTs). Instead of relying only on human input on a large volume of written responses in constructed-response tests, the system 100 uses NLP engine 122 to examine the impact of the tone used in written responses on scores assigned by human raters and the alignment between theoretical aspects of non-cognitive skills (e.g., professionalism) and the aspects extracted from written responses. The system can expand the QA process with new NLP-based applications, such as rater training procedures based on sentiment and subjectivity analyses and an automated scoring engine using transformers such as BERT to evaluate scoring accuracy. The system 100 can produce expected (or predicted) scores for a response in real-time and highlight the impact of different types of features such as tone, sentiment, subjectivity, and the alignment with theoretical aspects of non-cognitive skills (e.g., professionalism) on expected scores. The system 100 can provide this feedback to interfaces at electronic devices for display to guide human rating behaviours.

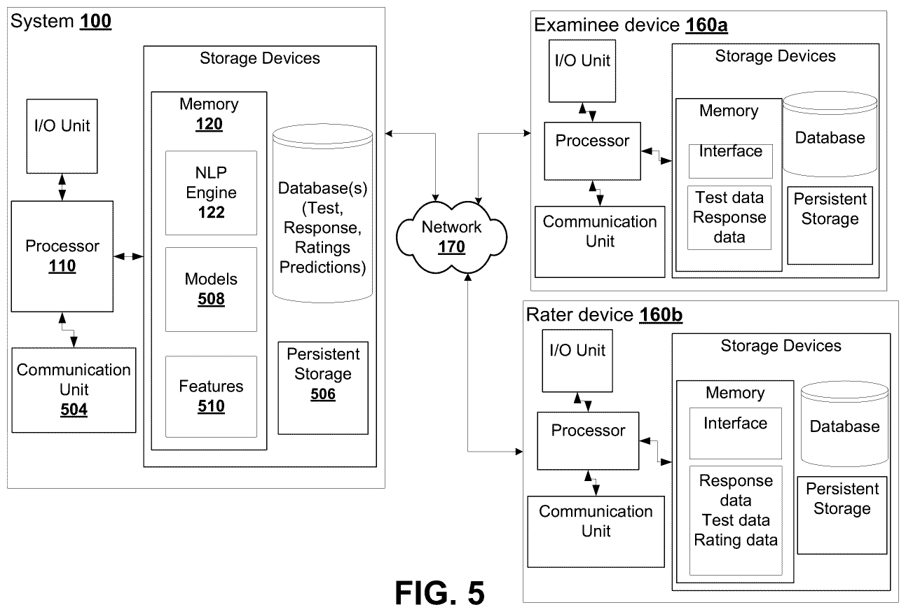

FIG. 5 shows another example system 100 for natural language processing for quality assurance of SJTs.

The computer system 100 uses natural language processing to generate quality assurance output for constructed-response tests. The system 100 has a memory, and a processor coupled to the memory programmed with executable instructions. The system 100 has a communication unit 504 for collecting rating data and response data for constructed-response tests. The processor 110 executes the instructions to provide an NLP engine 122 to generate predicted rating data for the response data for the constructed-response test. The processor 110 compares the predicted rating data to the rating data and generates quality assurance data based on results of the comparison.

The system 100 connects to an examinee electronic device 160a for collecting the response data for the constructed-response test. The device 160a has a transceiver for transmitting the collected response data to the interface. The device 160a also has an interface to display test data and collect response data corresponding to the test data. The system 100 connects to a rater electronic device 160b for collecting the rating data corresponding to the response data for the constructed-response test. The electronic device 160b has a transceiver for transmitting the collected rating data to the system 100. In some embodiments, the processor 110 transmits the quality assurance output data to the rater electronic device 160b for display, or stores the quality assurance output data in the memory 120.

In some embodiments, the processor 110 generates, using the response data, combined response data for multiple questions for a scenario of the constructed-response test. In some embodiments, the processor 110 extracts features 510 from the combined response data, and generates training data set and testing data set from the features 510.

In some embodiments, the processor 110 develops, trains and validates one or more models 508. For example, the processor 110 develops, trains and validates the models 508 using the training data. In some embodiments, the processor 100 selects a model from the one or more models 508, and generates the predicted ratings using the testing data set and the selected model.

In some embodiments, the processor 110 extracts features 510 from the response data, generates one or more models 508 using the extracted features 510, and generates the predicted ratings using a selected model of the one or more models 508.

In some embodiments, the system 100 has one or more cameras or sensors to generate the response data. For example, the system 100 can use a camera or sensor to collect video, audio or image data which can be used to generate response data for the tests.

In some embodiments, the processor 110 executes the instructions to configure the NLP engine 122 for sentiment analysis and unsupervised text classification to generate the predicted rating data for the response data for the constructed-response test. The processor 110 compares the predicted rating data to the rating data and generates quality assurance data based on results of the comparison. The system 100 couples to the examinee electronic device 160a for collecting the response data for the constructed-response test. The system connects to a rater electronic device 160b for collecting the rating data for the response data for the constructed-response test, and for transmitting the quality assurance output data for display. That way, the rater electronic device 160b can display the quality assurance output data corresponding to the rating data to provide real-time feedback on the rating data.

In some embodiments, the processor 110 uses the NLP engine 122 for the unsupervised text classification to categorize the response data based on similarities between the response data and one or more topics for the constructed response test. In some embodiments, the processor 110 determines alignment between the one or more topics for the constructed response test, the response data, and the rating data to compute precision and recall for the one or more topics for the constructed response test. In some embodiments, the processor 110 uses the NLP engine 122 for the unsupervised text classification to assign labels or categories to the response data and evaluate alignment between the assigned labels or categories and one or more topics or aspects of the constructed response test. In some embodiments, the processor 110 uses the NLP engine 122 for the sentiment analysis to compute sentiment and subjectivity scores for the response data.

Accordingly, the system 100 provides for automatic scoring QA data to identify rating outliers for re-review. The system 100 has an NLP engine 122 with models to automatically generate predicted ratings for response data for constructed-response tests. The system 100 trains the models using training data (e.g., from historical response data). The system 100 tests the models using testing data (e.g., from historical response data). NLP engine 122 uses the models to generate predicted ratings that represents machine predictions of what rating a human rater will assign/had assigned to response data for a constructed-response test. As a (non-limiting) illustrative example, the system 100 can correlate writing quality features to student scoring, and the system 100 can determine that there is a high accuracy of prediction of ratings using this correlation to writing quality. The system can generate accurate predictions for ratings on a set of testing data using a (relatively small) set of training data.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

One should appreciate that the systems and methods described herein may provide different example technical effects and solutions such as better memory usage, improved processing, improved bandwidth usage, improved machine learning processes, application of natural language processing for automatically generating predictions.

The following discussion provides many example embodiments. Although each embodiment represents a single combination of inventive elements, other examples may include all possible combinations of the disclosed elements. Thus if one embodiment comprises elements A, B, and C, and a second embodiment comprises elements B and D, other remaining combinations of A, B, C, or D, may also be used.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, a removable hard disk, and so on. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

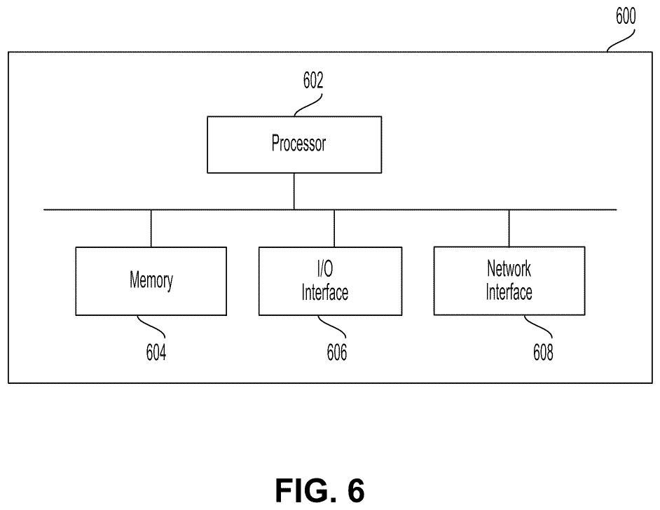

FIG. 6 is a schematic diagram of computing device 600 that can be used to implement aspects of embodiments described herein such as electronic device 160 and system 100. As depicted, computing device 600 includes at least one processor 602, memory 604, at least one I/O interface 606, and at least one network interface 608.

Each processor 602 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof.

Memory 604 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM), or the like.

Each I/O interface 606 enables computing device 600 to interconnect with one or more input devices, such as a keyboard, mouse, camera, touch screen and a microphone, or with one or more output devices such as a display screen and a speaker.

Each network interface 608 enables computing device 600 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi, WiMAX), SS7 signaling network, fixed line, local area network, wide area network, and others, including any combination of these.

Computing device 600 is operable to register and authenticate users (using a login, unique identifier, and password, for example) prior to providing access to applications, a local network, network resources, other networks and network security devices. Computing devices 400 may serve one user or multiple users.

NLP engine 122 can use different example models as described herein. For example, models can be LLMs such as BERT and Falcon. System can use a pre-defined rubric as input to an LLM alongside written responses from students and instructing the LLM to evaluate the responses against the specified rubric criteria for educational testing. System can provide training examples to models to direct them to what are positive/negative cases. System can efficiently use training data and could avoid training examples by relying on the LLMs' interpretation of the rubric criteria. Other examples include Lbl2Vec: BERTopic, or models leveraging technology for document embeddings such as Doc2Vec, Ada, Universal Sentence Encoder, and SBERT. Other example models as VADER: TextBlob, Flair, Stanza, or an LLM with prompts to classify sentiment. Other example models include Xgboost: support vector machines, linear regressions, random forest models, and neural networks.

Although the embodiments have been described in detail, it should be understood that various changes, substitutions and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

As can be understood, the examples described above and illustrated are intended to be exemplary only.

What is claimed is:

1. A computer system for natural language processing for quality assurance and automatic response assessment for constructed-response tests, the system comprising:
a memory storing one or more generative models;
a processor coupled to the memory programmed with executable instructions, the instructions including an interface for obtaining response data for a constructed-response test from a plurality of examinee electronic devices, wherein the processor executes the instructions to provide a natural language processing engine to generate predicted rating data for the response data for the constructed-response test using one or more generative models and one or more large language models, wherein the predicted rating data comprises ratings or scores of the response data for the constructed-response test, wherein the processor compares the predicted rating data to the response data and generates quality assurance data based on results of the comparison using one or more models, wherein processor uses the one or more generative models to generate feedback data about the response data, wherein the quality assurance data comprises the feedback data, wherein the processor uses the predicted rating data and the feedback data for one or more of identification of improvement areas, generation of individualized learning plans, curriculum reform, and monitoring;
wherein the processor receives the response data from the plurality of examinee electronic devices, each of the devices having a transceiver for transmitting collected response data to the interface.

2. The system of claim 1 wherein the processor de-personalizes the response data and aggregates de-personalized response data for automating program or curriculum review.

3. The system of claim 1, further comprising a rater electronic device for collecting the rating data for the response data for the constructed-response test, the electronic device having a transceiver for transmitting the collected rating data to the interface, wherein the processor compares the predicted rating data to the rating data and generates additional quality assurance data about the rating data based on results of the comparison using the one or more models.

4. The system of claim 1, wherein the processor generates, using the response data, combined response data for multiple questions for a scenario of the constructed-response test.

5. The system of claim 2, wherein the processor extracts features from the combined response data, and generates training data set and testing data set from the features for training and testing the one or more models.

6. The system of claim 3, wherein the processor develops, trains and validates the one or more models using the training data and the extracted features and rating data.

7. The system of claim 4 wherein the processor selects a model from the one or more models, and generates the predicted ratings using the testing data set and the selected model.

8. The system of claim 1 wherein the processor uses the natural language processing engine for unsupervised text classification to categorize the response data based on similarities between the response data and one or more topics for the constructed response test.

9. The system of claim 6 wherein the processor determines alignment between the one or more topics for the constructed response test, the response data, and the rating data to compute precision and recall data for the one or more topics for the constructed response test.

10. The system of claim 1 wherein the processor uses the natural language processing engine for unsupervised text classification to assign labels or categories to the response data and evaluate alignment between the assigned labels or categories and one or more topics or aspects of the constructed response test.

11. The system of claim 1 wherein the processor uses the natural language processing engine for sentiment analysis to compute sentiment and subjectivity scores for the response data.

12. The system of claim 1 wherein the processor transmits the quality assurance output data to the rater electronic device for display using one or more visual elements or stores the quality assurance output data in the memory.

13. The system of claim 1 wherein the processor extracts features from the response data, generates one or more models using the extracted features, and generates the predicted ratings using a selected model of the one or more models.

14. The system of claim 1 further comprises one or more cameras or sensors to generate the response data.

15. A computer system for natural language processing for quality assurance and response assessment for constructed-response tests, the system comprising:
a memory;
a processor coupled to the memory programmed with executable instructions, the instructions including an interface for obtaining response data for a constructed-response test, wherein the processor executes the instructions to provide a natural language processing engine for sentiment analysis and unsupervised text classification to generate predicted rating data for the response data for the constructed-response test, wherein the predicted rating data comprises ratings or scores of the response data for the constructed-response test, wherein processor uses the one or more generative models to generate feedback data about the response data; and
a plurality of examinee electronic devices, each examinee electronic device configured for collecting the response data for the constructed-response test, the device having a transceiver for transmitting the collected response data to the interface.

16. The system of claim 15 wherein the processor uses the natural language processing engine for the unsupervised text classification to categorize the response data based on similarities between the response data and one or more topics for the constructed response test.

17. The system of claim 16 wherein the processor determines alignment between the one or more topics for the constructed response test, the response data, and the rating data to compute precision and recall for the one or more topics for the constructed response test.

18. The system of claim 15 wherein the processor uses the natural language processing engine for the unsupervised text classification to assign labels or categories to the response data and evaluate alignment between the assigned labels or categories and one or more topics or aspects of the constructed response test.

19. The system of claim 15 wherein the processor uses the natural language processing engine for the sentiment analysis to compute sentiment and subjectivity scores for the response data.

20. A computer process for natural language processing for quality assurance and response assessment for constructed-response tests, the process comprising:
by a processor coupled to memory programmed with executable instructions, the instructions including an interface for obtaining response data for a constructed-response test, wherein the processor executes the instructions to provide a natural language processing engine,
generating, using the response data, combined response data for multiple questions for a scenario of the constructed-response test;
extracting features from the combined response data;
generating training data set and testing data set from the features;
developing, training and validating one or more models using the training data;
selecting a model from the one or more models;
generating predicted ratings using the selected model and sentiment analysis and unsupervised text classification, wherein the predicted rating data comprises ratings or scores of the response data for the constructed-response test;
generating feedback data for the response data using the predicted ratings; and
transmitting the feedback data to an electronic device for display or storing the feedback data in the memory.
